(19) United States
(12) Patent Application Publication
(10) Pub. No.: US 2013/0071282 A1
(43) Pub. Date: Mar. 21, 2013

(54) Method For Securing A Stop Member To A Seal Plate Configured For Use With An Electrosurgical Instrument

(71) Applicant: Monte S. Fry, Longmont, CO (US)

(72) Inventor: Monte S. Fry, Longmont, CO (US)

(73) Assignee: TYCO Healthcare Group LP, Boulder, CO (US)

(21) Appl. No.: 13/236,271

(22) Filed: Sep. 19, 2011

(51) Int. Cl. B22F 7/08; B23P 11/00

(52) U.S. Cl. 419/8; 29/428

(57) ABSTRACT

A method for affixing a stop member to a seal plate for use with electrosurgical instruments is provided. An aperture is formed on a seal plate during a metal injection molding process thereof. A stop member is positioned within the aperture on the seal plate. The seal plate is, subsequently, sintered with the stop member positioned in the aperture.

### BACKGROUND

1. Technical Field

The present disclosure relates to a method for securing a stop member to a seal plate for use with an electrosurgical instrument. More particularly, the present disclosure relates to securing a stop member to a seal plate manufactured via a metal injection molded manufacturing process.

2. Description of Related Art

Electrosurgical instruments, e.g., endoscopic forceps, are well known in the medical arts. In most instances, the electrosurgical instrument includes a housing, a handle assembly including a movable handle, a shaft and an end effector assembly attached to a distal end of the shaft. The end effector includes jaw members configured to manipulate tissue (e.g., grasp and seal tissue); one (monopolar forceps) or both (bipolar forceps) of the jaw members, typically, include respective seal plates. Typically, the endoscopic forceps utilizes both mechanical clamping action and electrical energy to effect hemostasis by heating the tissue and blood vessels to coagulate, cauterize, seal, cut, desiccate, and/or fulgurate tissue.

In order to maintain specific gap distances between the jaw members when the jaw members are in a clamping position with tissue grasped therebetween, one or more insulative stop members may be positioned along one or both seal surfaces of the seal plate(s). The stop members may be secured to the seal plates via one or more suitable securement methods. For example, and in certain instances, the stop members may be secured to the seal surface of the seal plate utilizing one or more suitable adhesives, e.g., curable adhesives. However, this technique is typically complicated and requires specialty equipment/processes that increase the manufacturing cost of the seal plates, and, thus, the overall manufacturing costs of the electrosurgical instrument. Moreover, the stop member may be vulnerable to shear stress failure due to the nature of the adhesive. That is, there exists the possibility of the adhesive not curing properly and succumbing to the shear stresses that may be present during an electrosurgical process, i.e., during the grasping and subsequent sealing of tissue.

### SUMMARY

An aspect of the present disclosure includes providing a method for affixing a stop member to seal plate configured for use with electrosurgical instruments. An aperture is formed on a seal plate during a metal injection molding process thereof. A stop member is positioned within the aperture on the seal plate. The seal plate is, subsequently, sintered with the stop member positioned in the aperture.

In certain instances, the step of positioning the stop member within the aperture is completed during a brown stage and after a de-binding process of the metal injection molding process.

In certain instances, forming the stop member includes forming the stop member from a ceramic material. Moreover, the stop member can be made via one of a machining process and an injection molding process.

In some instances, a height of the stop member can be larger than a height of the seal plate such that the stop member extends past a seal surface of the seal plate when the stop member is secured within to the seal plate. A height of the stop member may range from about 0.001 inches and about 0.006 inches.

In certain instances, the method may include positioning a hard stop feature within the aperture on the seal plate prior to positioning the stop member into the aperture. The hard stop feature can be configured to raise the stop member above a seal surface of the seal plate.

Sintering the seal plate can include transitioning the seal plate from an initial oversized configuration that is configured to receive the stop member therein, to a final shrunken configuration that is configured to secure the stop member within the seal plate.

Another aspect of the present disclosure includes providing a method for setting a gap distance between electrosurgical jaws. The method includes positioning a stop member within an aperture in a seal plate such that the stop member extends a distance above a seal surface of the seal plate. Thereafter, the seal plate is heated to cause the seal plate to shrink such that the aperture engages the stop member to secure the stop member within the seal plate.

In certain instances, the step of positioning the stop member within the aperture can be completed during a brown stage and after a de-binding process of a metal injection molding process utilized to form the seal plate.

The method can include the step of forming the stop member from a ceramic material. In certain instances, the stop member can be made via one of a machining process and an injection molding process.

In certain instance, a height of the stop member is larger than a height of the seal plate such that the stop member extends past the seal plate surface of the seal plate when the stop member is secured within to the seal plate. A height of the stop member may range from about 0.001 inches and about 0.006 inches.

In certain instances, the method may include positioning a hard stop feature within the aperture on the seal plate prior to positioning the stop member into the aperture. The hard stop feature can be configured to raise the stop member above a seal surface of the seal plate.

Heating the seal plate can include transitioning the seal plate from an initial oversized configuration that is configured to receive the stop member therein, to a final shrunken configuration that is configured to secure the stop member within the seal plate.

In accordance with either of the aforementioned methods, the aperture can be formed on the seal plate via an etching process.

In accordance with either of the aforementioned methods, the aperture can be formed entirely or partially through the seal plate.

### BRIEF DESCRIPTION OF THE DRAWING

Various embodiments of the present disclosure are described hereinbelow with references to the drawings, wherein:

FIG. 1 is a perspective view of an endoscopic forceps including seal plates manufactured via a method according to an embodiment of the present disclosure;

FIG. 2 is an enlarged, perspective view of one of the seal plates of FIG. 1 and corresponding stop members prior to positioning the stop members therein;

FIG. 3 is schematic view of one of the seal plates of FIG. 1 including a stop member disposed therein illustrated in a “pre-sintered” or “brown” state of the manufacturing process thereof;

FIG. 4 is schematic view of the seal plate of FIG. 3 including a stop member disposed therein illustrated in a sintered state of the manufacturing process thereof;

FIG. 5 is a flow chart illustrating a method of manufacture of the seal plate depicted in FIG. 1;

FIG. 6 is schematic view of one of the seal plates of FIG. 1 including a stop member disposed therein, the seal plate and stop member illustrated in a “pre-sintered” or “brown” state of the manufacturing process thereof according to another embodiment of the present disclosure;

FIG. 7 is schematic view of the seal plate of FIG. 6 including a stop member disposed therein illustrated in a sintered state of the manufacturing process thereof;

FIG. 8 is schematic view of one of the seal plates of FIG. 1, including a stop member disposed therein, the seal plate and stop member illustrated in a “pre-sintered” or “brown” state of the manufacturing process thereof according to another embodiment of the present disclosure;

FIG. 9 is schematic view of the seal plate of FIG. 8 including a stop member disposed therein illustrated in a sintered state of the manufacturing process thereof;

FIG. 10 is schematic view of one of the seal plates of FIG. 1, including a stop member disposed therein, the seal plate and stop member illustrated in a “pre-sintered” or “brown” state of the manufacturing process thereof according to yet another embodiment of the present disclosure; and

FIG. 11 is schematic view of the seal plate of FIG. 10 including a stop member disposed therein illustrated in a sintered state of the manufacturing process thereof.

### DETAILED DESCRIPTION

Detailed embodiments of the present disclosure are disclosed herein; however, the disclosed embodiments are merely examples of the disclosure, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

In the drawings and in the descriptions that follow, the term “proximal,” as is traditional, will refer to an end of a surgical instrument that is closer to the user, while the term “distal” will refer to an end of the surgical instrument that is farther from the user.

In accordance with the instant disclosure, a unique method of securing a “gap setting feature,” e.g., a stop member, to a seal plate is described herein. The method includes securing a stop member to a seal plate manufactured via a metal injection molded (MIM) process. During a MIM process, the seal plate can be molded “oversized” to a desired shape, and, subsequently, sintered down to a shrunken size. Seal plates manufactured via a MIM process can be utilized with various electrosurgical instruments, e.g., electrosurgical instruments that include jaw members configured to grasp and, subsequently, treat tissue, e.g., seal tissue.

A method for securing a stop member to a seal plate configured for use with an endoscopic bipolar forceps is described.

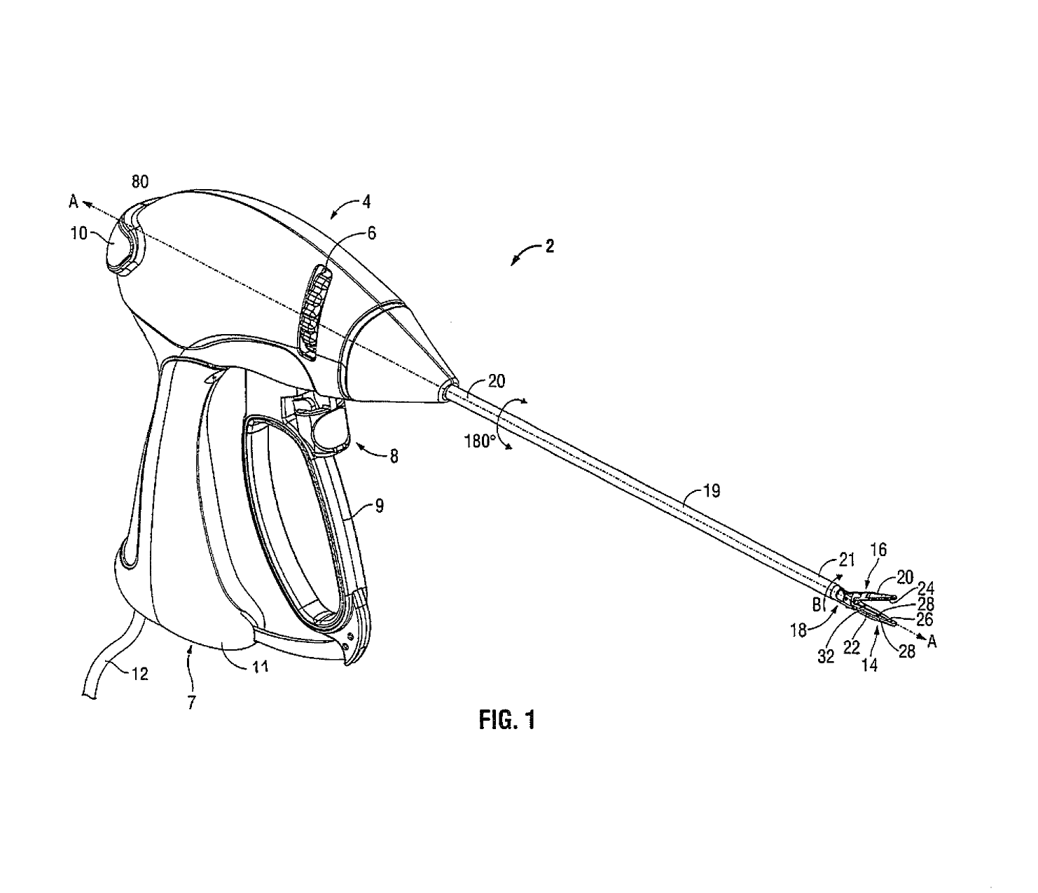

FIG. 1 shows in detail the operating features and inter-cooperating components of an endoscopic bipolar forceps generally identified as forceps 2. Briefly, forceps 2 is for use with various surgical procedures and includes: a housing 4 configured to support a shaft 19 that defines a longitudinal axis “A-A” therethough; a rotating assembly 6; a trigger assembly 8; a switch 10; an electrosurgical cable 12 for connecting the forceps 2 to an electrosurgical generator (not shown); a drive assembly (not shown), a handle assembly 7 including movable and stationary handles 9 and 11, respectively, and an end effector assembly 14. These various components mutually cooperate to grasp, seal and divide various tissues, for example, tubular vessels and vascular tissues. For a more detailed description of the trigger assembly 8, switch 10, and electrosurgical cable 12, reference is made to commonly-owned U.S. Pat. No. 7,156,846 to Dycus et al. filed on Jun. 13, 2003.

With continued reference to FIG. 1, end effector 14 is supported at a distal end 21 of the shaft 19 and includes jaw members 16 and 18. In the embodiment illustrated in FIG. 1, the jaw members 16 and 18 are of the unilateral type, i.e., one of the jaw members, e.g., jaw member 16, is movable and the other jaw member, e.g., jaw member 18, is stationary. It is contemplated that the jaw members 16 and 18 may be of the bilateral type, i.e., each of the jaw members 16 and 18 are movable with respect to one another.

Each of the jaw members 16 and 18 may be manufactured via any suitable manufacturing technique, injection molding, overmolding, metal injection molding (MIM), etc. In the illustrated embodiment the jaw members 16 and 18 are manufactured via MIM.

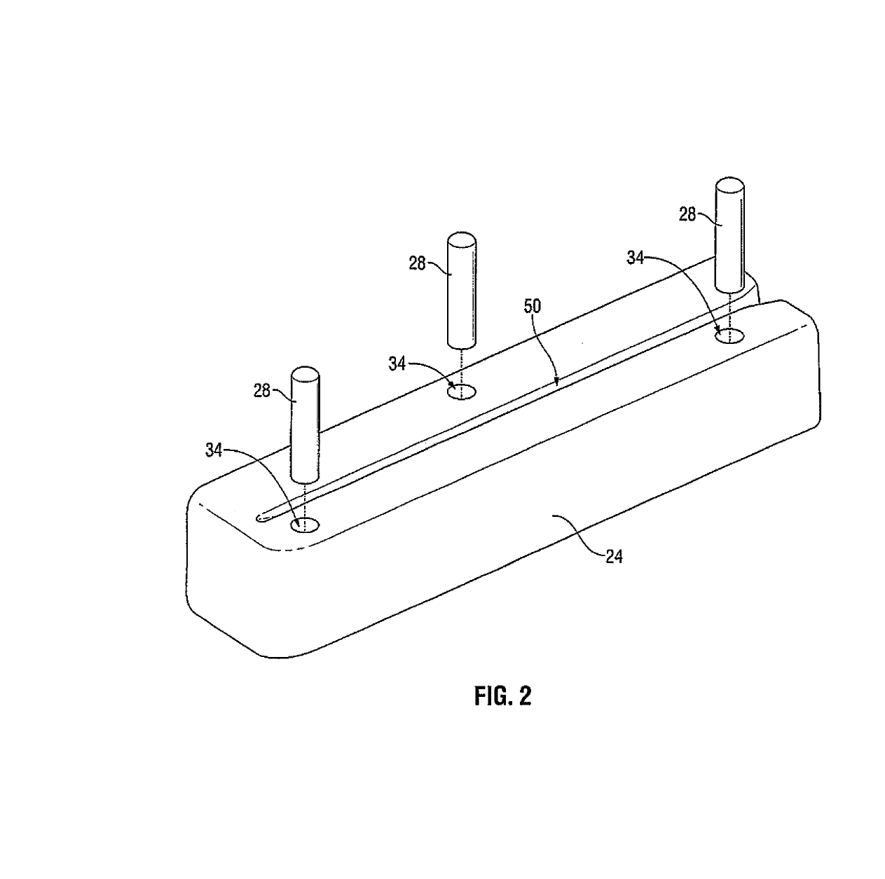

Each jaw member 16 and 18 includes a respective jaw housing 20 and 22 and respective seal plates 24 and 26, see FIG. 1. In some embodiments, one or more stop members 28 (FIGS. 1-4) can be secured to an interior of the seal plates 24 and 26 to extend above respective seal plate surfaces 30 and 32 (FIGS. 1-4). For illustrative purposes, stop members 28 are positioned on both sides of a knife slot 50 of the seal plate 24, see FIG. 2. As can be appreciated, the specific configuration of the stop member(s) 28 on the seal plates 24 and 26 may depend on a specific surgical instrument, specific surgical procedure, required gap distance between the jaw members 16 and 18 when the jaw members 16 and 18 are in a clamping configuration, manufacturer's preference, etc. The stop member(s) 28 can be made from any suitable non-conductive or insulative material. In the illustrated embodiment, the stop member(s) 28 is made from a suitable ceramic material that is electrically insulative with high temperature resistance. That is, a suitable ceramic material is one that is capable of withstanding the high sintering temperatures that are typically associated with the MIM manufacturing process. In other words, the ceramic material does not shrink during the sintering process. The stop member(s) 28 can be in the form of a ceramic insert that is fabricated via a machining process (e.g., machining ceramic rods or slugs) or an injection molding process. The stop member(s) 28 may include any suitable shape and length. In the illustrated embodiment, the stop member(s) 28 include a generally cylindrical configuration; however, other configurations (square, rectangular, oval, etc.) are contemplated.

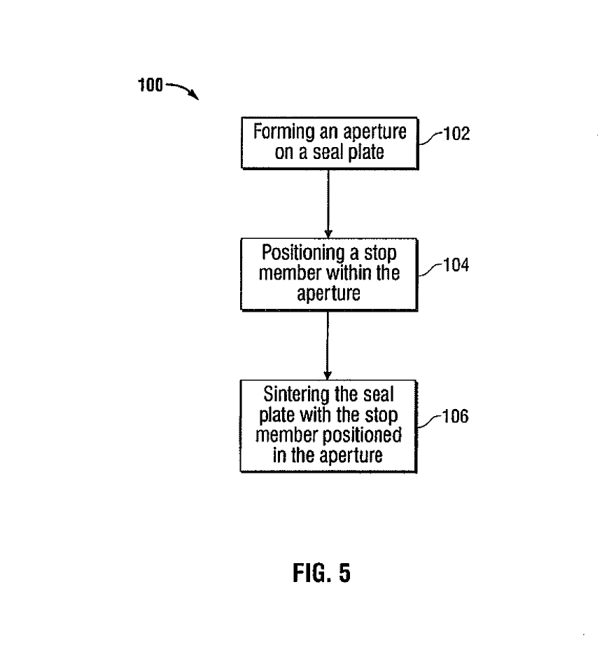

In accordance with the present disclosure, the stop member(s) 28 is secured to an interior of the seal plates 16 and 18 and extends a predetermined distance above the seal plate surfaces 30 and 32 during the MIM manufacture process of the jaw members 16 and 18. A method 100 of manufacture for affixing or securing the stop member(s) 28 to one or both of the seal plates 24 and 26 is illustrated in FIG. 5. For illustrative purposes, the method 100 is described in terms of affixing the stop member(s) 28 to the seal plate 24 of the jaw member 16. To facilitate securing the stop member(s) 28 to the seal plate 24, the seal plate 24 can be molded to be “oversized” during the MIM process, the significance of which is discussed in detail below.

Continuing with reference to FIG. 5, at step 102, an aperture or slot 34 can be formed on and/or molded into the seal plate 24 during the MIM process. In one embodiment, the stop member 28 has an outer dimension that is smaller than a dimension of the slot 34 such that when the stop member(s) 28 is placed within the aperture 34, a gap “G1” is formed between the stop member 28 and the seal plate 24 (see FIG. 3). The slot 34 can have any suitable shape, but generally can have a shape to match a shape of the stop member(s) 28. In one particular embodiment, the step of positioning the stop member(s) 28 (see FIG. 5 at step 104) within the aperture 34 is completed during a “brown” stage or “pre-sintering stage” and after a de-binding process of the MIM process such that the seal plate is still in its “oversized” state.

In embodiments, the aperture 34 can extend entirely (e.g., a throughbore) or partially (e.g., a “blind” aperture) through the seal plate 24, as described in greater detail below.

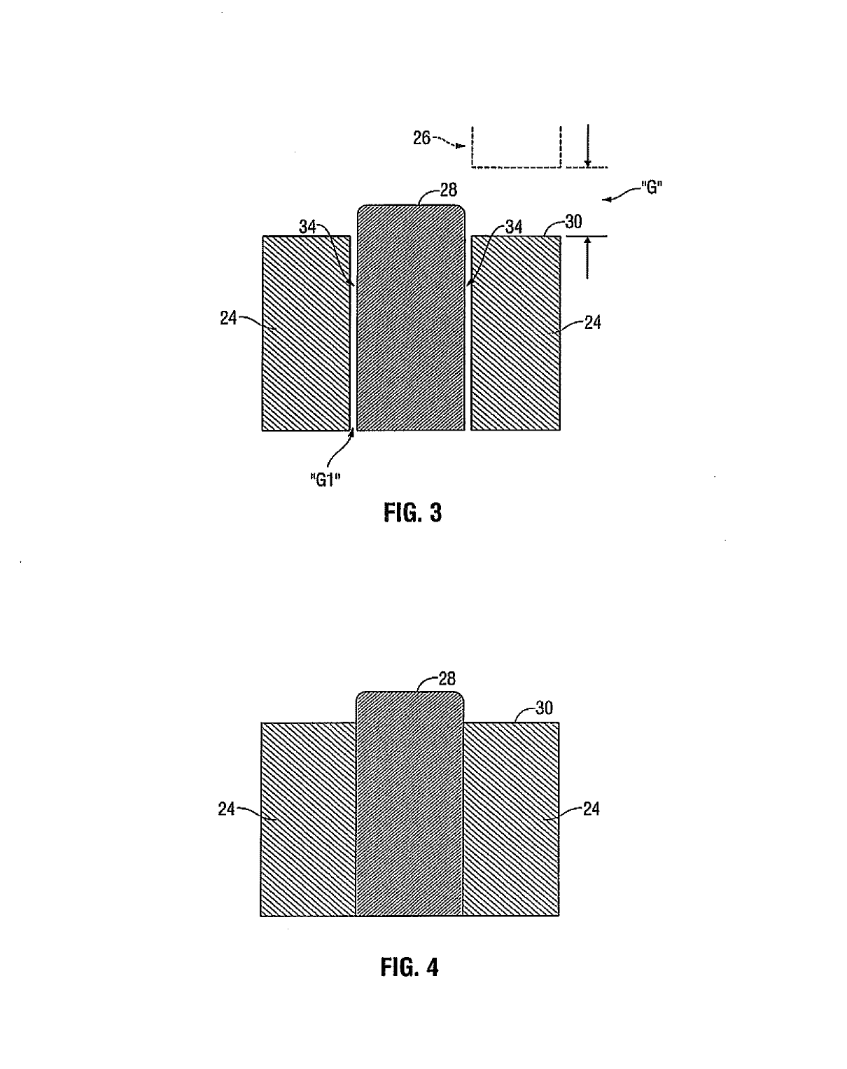

There are a number of ways in which to control a height of the stop member 28 above the seal plate 24. For example, in the embodiment illustrated in FIGS. 3 and 4, the stop member(s) 28 includes a height that is larger than a height of the seal plate 24 such that the stop member(s) 28 extends past the seal surface 30 of the seal plate 24 when the stop member(s) 28 is permanently affixed to the seal plate 24, as best seen in FIG. 4. In this case, aperture 34 extends through the seal plate 24 and a bottom surface of the stop member(s) 28 is substantially flush with a bottom surface of the seal plate 24. In this embodiment, a substrate (not explicitly shown) of suitable configuration may be positioned beneath the seal plate 24 and utilized to maintain the stop member(s) 28 in an upright position.

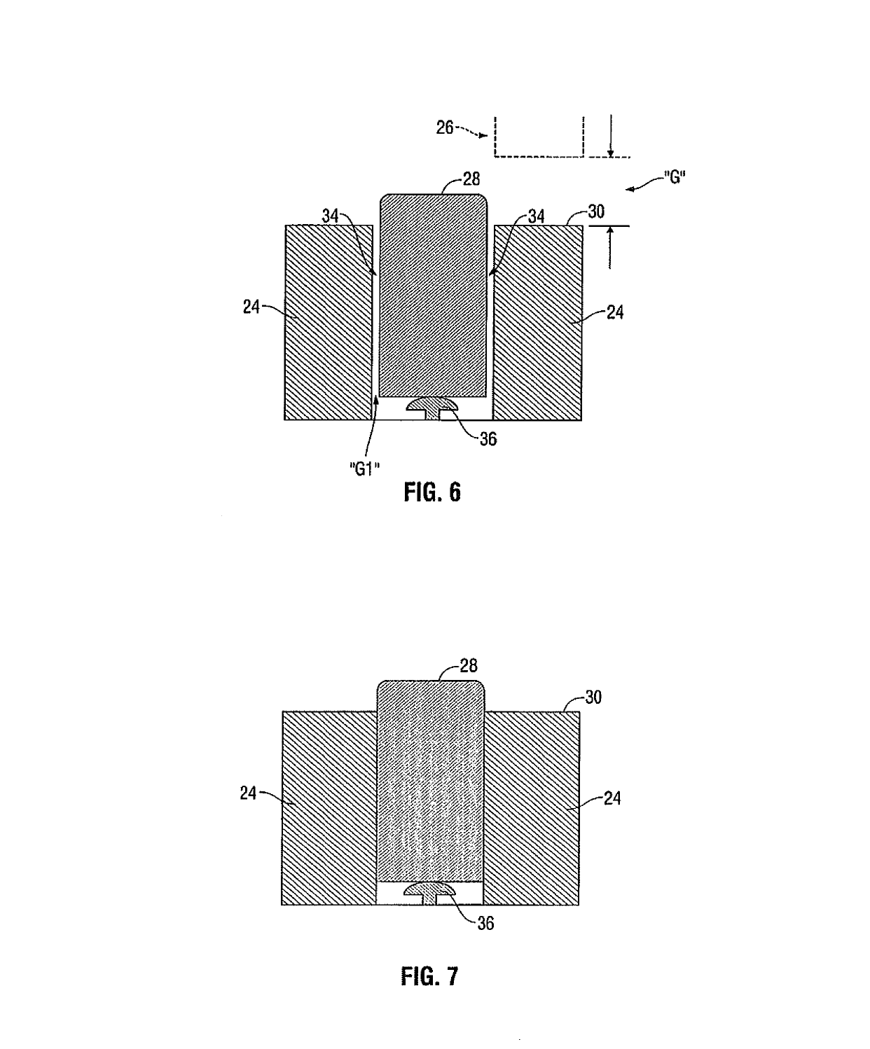

Alternatively, a hard “stop feature” 36 may be positioned within the aperture 34 on the seal plate 24 prior to positioning the stop member(s) 28 into the aperture 34, see FIGS. 6 and 7. In this instance, the hard stop feature 36 is configured to raise the stop member(s) 28 above the seal surface 30 of the seal plate 24. The hard “stop feature” 36 may be any suitable hard “stop feature.” For example, in one particular embodiment, the hard “stop feature” may be in the form of ceramic insert or other suitable non-conductive or insulative material of suitable configuration configured to raise the stop member(s) 28 a predetermined distance above the seal surface 30. In the embodiment illustrated in FIGS. 6 and 7, the hard “stop feature” 36 is in the form of a ceramic slug or insert having a generally “mushroomed” shape, as best seen in FIGS. 6 and 7. As can be appreciated, other types of hard “stop features” may be utilized to raise the stop member(s) a predetermined distance above the seal surface 30 of the seal plate 24. In the embodiment illustrated in FIGS. 6 and 7, aperture 34 extends partially through the seal plate 24 and a portion of the seal plate 24 may be utilized to maintain the “hard stop feature” and/or the stop member(s) 28 in an upright position. Alternatively, and as with the embodiment illustrated in FIGS. 3 and 4, the aperture 34 may extend entirely through the seal plate 24 and a substrate may be positioned beneath the seal plate 24 to maintain the “hard stop feature” and/or the stop member(s) 28 in an upright position.

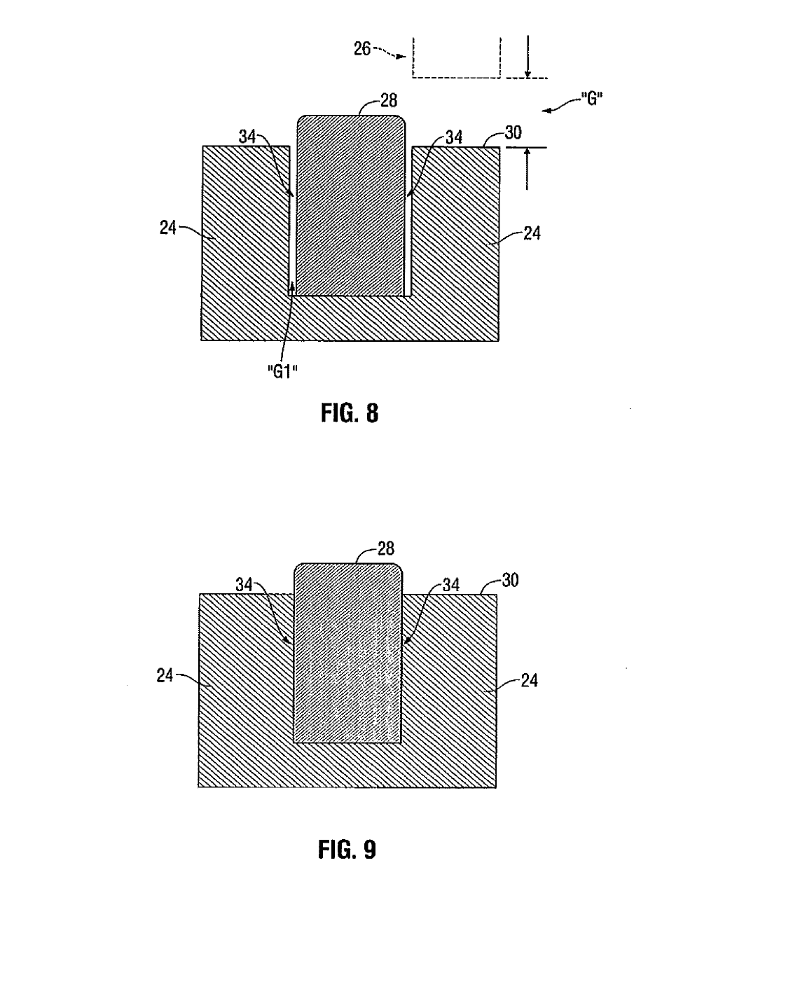

In yet another embodiment, see FIGS. 8 and 9 for example, a depth at which the aperture 34 extends into the seal plate 24 can adjusted to elevate the stop member(s) 28 a predetermined distance above the seal surface 30 of the seal plate 24.

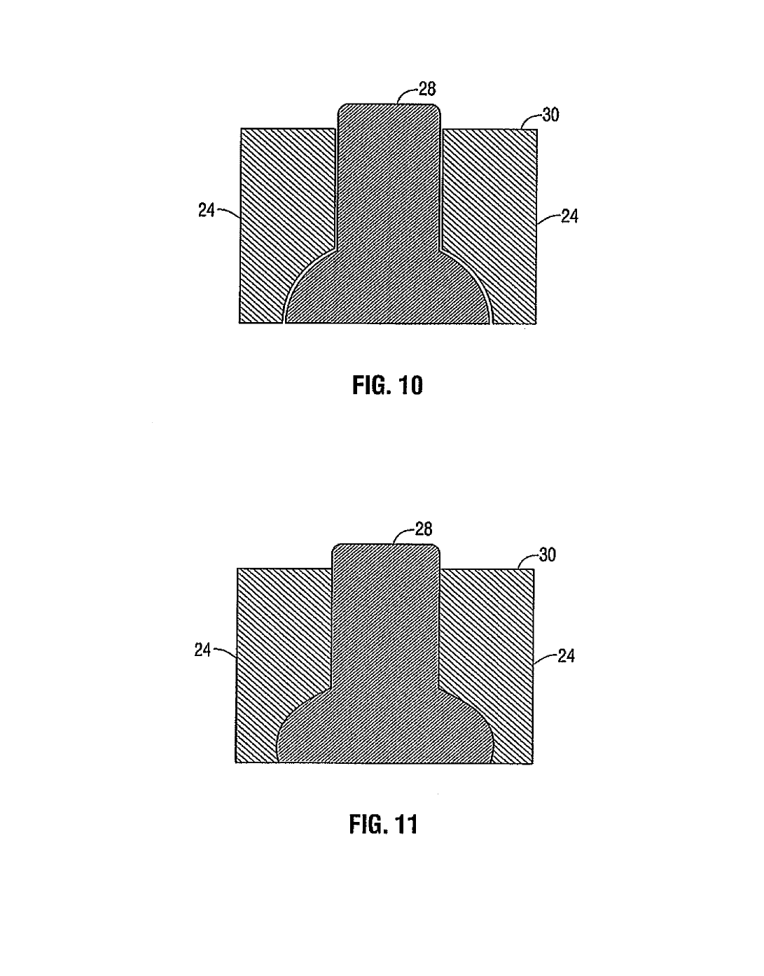

In still yet another embodiment, see FIGS. 10 and 11 for example, the stop member(s) 28 can have a “stop feature” feature formed thereon. In this particular embodiment, the stop member(s) 28 can have a broadened bottom portion (not unlike that of a screw-head) and the seal plate 24 can have an aperture 34 with a counter-bore configuration; this particular embodiment is particularly useful when the seal plates 24 are configured to be relatively thin. In the embodiment illustrated in FIGS. 10 and 11, to facilitate positioning the stop member(s) into the aperture 34, the stop member(s) 28 can be positioned on the substrate and the seal plate 24 can be, subsequently, positioned thereover.

Once the stop member(s) 28 is properly positioned within the aperture 34 of the seal plate 24, the seal plate 24 can be subjected to a final sintering process, see FIG. 5 at step 106. As noted above, the seal plate 24 is molded “oversized” during the MIM manufacturing process. In accordance with the present disclosure, during the final sintering process, the seal plate 24 transitions from an initial, oversized configuration that is configured to receive the stop member(s) 28 therein (see FIGS. 2 and 3, for example), to a final, shrunken configuration that fixedly secures the stop member(s) 28 to the seal plate 24, see FIG. 4, for example. In embodiments, the seal plate 24 may be configured to shrink an amount that ranges from about 10-30% its original, pre-sintered configuration. Accordingly, the aperture 34 and/or gap “G1” is approximately 10-30% larger in its pre-sintered configuration when compared to its post-sintered configuration. During the final sintering process, the brown or “pre-sintered” seal plate 24 shrinks, thus, collapsing the gap “G1” on the stop member(s) 28. As a result thereof, this shrinking functions as a uniform locking mechanism around the stop member(s) 28, thus allowing the stop member(s) 28 to be secured in place without the use of adhesives or complicated techniques.

Accordingly, the present disclosure provides an easy and low cost manufacture method for affixing a stop member(s) 28 to the seal plate 24. Moreover, the stop member(s) 28 affixed to the seal plate 24 in a manner consistent with the present disclosure, e.g., disposed within the seal plate 24, are more resistant to shear failure than stop members affixed to seal plates via conventional methods, e.g., adhesives.

In addition to the foregoing, stop member(s) 28 allows a gap “G” to be set between the jaw members 20 and 22 when the jaw members 20 and 22 are in the clamping position (see FIGS. 3 and 6). In some embodiments, the gap “G” can range from about 0.001 inches to about 0.006 inches. In other embodiments, gap “G” can range from about 0.01 inches to about 0.06 inches or from about 0.1 inches to about 0.6 inches. In the instance where one of the jaw members includes stop member(s) 28, the stop member(s) 28 may include a height that ranges from about 0.001 inches to about 0.006 inches. In one particular embodiment, such as, for example, when both the jaw members 20 and 22 include stop member(s) 28, the stop members 28 may be in vertical registration with one another. In this instance, the combined height of the stop members 28 will range from about 0.001 inches to about 0.006 inches. Thus, for example, in the instance where the desired gap “G” is equal to 0.006 inches, each of the stop members 28 may include a height that is equal to 0.003 inches. As can be appreciated, the height of the stop member(s) 28 may be adjusted for a particular surgical procedure, manufacturer's preference, etc.

From the foregoing and with reference to the various figure drawings, those skilled in the art will appreciate that certain modifications can also be made to the present disclosure without departing from the scope of the same. For example, in certain instances, it may prove advantageous to form the aperture in the seal plate 24 via etching or photolithography processes. One such etching process is described in commonly-owned U.S. patent application Ser. No. 12/568,199 to Brandt et al. filed on Sep. 28, 2009.

Moreover, the aforementioned securement methods can be utilized in combination with the manufacture of any device that includes jaw members having seal plates which require securement of stop members thereon, e.g., open style forceps.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A method for securing a stop member to a seal plate for use with electrosurgical instruments, comprising:
forming an aperture on a seal plate during a metal injection molding process thereof;
positioning a stop member within the aperture on the seal plate; and
sintering the seal plate with the stop member positioned in the aperture to secure the stop member within the seal plate.

2. The method according to claim 1, wherein the step of positioning the stop member within the aperture is completed during a brown stage and after a de-binding process of the metal injection molding process.

3. The method according to claim 1, wherein forming the stop member includes forming the stop member from a ceramic material.

4. The method according to claim 1, wherein the stop member is made via one of a machining process and an injection molding process.

5. The method according to claim 1, wherein a height of the stop member is larger than a height of the seal plate such that the stop member extends past a seal surface of the seal plate when the stop member is secured within to the seal plate.

6. The method according to claim 1, wherein a height of the stop member ranges from about 0.001 inches and about 0.006 inches.

7. The method according to claim 1, further including positioning a hard stop feature within the aperture on the seal plate prior to positioning the stop member into the aperture, wherein the hard stop feature is configured to raise the stop member above a seal surface of the seal plate.

8. The method according to claim 1, wherein sintering the seal plate includes transitioning the seal plate from an initial oversized configuration that is configured to receive the stop member therein, to a final shrunken configuration that is configured to secure the stop member within the seal plate.

9. The method according to claim 1, wherein forming an aperture on a seal plate includes forming the aperture via an etching process.

10. The method according to claim 1, wherein forming an aperture on a seal plate includes forming the aperture entirely through the seal plate.

11. The method according to claim 1, wherein forming an aperture on a seal plate includes forming the aperture partially through the seal plate.

12. A method for setting a gap distance between electrosurgical jaws, comprising:
positioning a stop member within an aperture in a seal plate such that the stop member extends a distance above a seal surface of the seal plate; and
heating the seal plate to cause the seal plate to shrink such that the aperture engages the stop member to secure the stop member within the seal plate.

13. The method according to claim 12, wherein the step of positioning the stop member within the aperture is completed during a brown stage and after a de-binding process of a metal injection molding process utilized to form the seal plate.

14. The method according to claim 12, further including the step of forming the stop member from a ceramic material.

15. The method according to claim 12, wherein the stop member is made via one of a machining process and an injection molding process.

16. The method according to claim 12, wherein a height of the stop member is larger than a height of the seal plate such that the stop member extends past the seal plate surface of the seal plate when the stop member is secured within to the seal plate.

17. The method according to claim 12, wherein a height of the stop member ranges from about 0.001 inches and about 0.006 inches.

18. The method according to claim 12, further including positioning a hard stop feature within the aperture on the seal plate prior to positioning the stop member into the aperture, wherein the hard stop feature is configured to raise the stop member above the seal surface of the seal plate.

19. The method according to claim 12, wherein heating the seal plate includes transitioning the seal plate from an initial oversized configuration that is configured to receive the stop member therein, to a final shrunken configuration that is configured to secure the stop member within the seal plate.

20. The method according to claim 12, further including the step of forming the aperture on the seal plate via an etching process.
